(19) United States
(12) Patent Application Publication
(10) Pub. No.: US 2013/0058200 A1
(43) Pub. Date: Mar. 7, 2013

(54) METHOD FOR CALIBRATING TILT OF ACTUATOR BY OFFSETTING CONTROL VOLTAGE

(71) Applicants: I-Bing Su, Taoyuan County (TW); Yi-Long Hsiao, Taoyuan County (TW)

(72) Inventors: I-Bing Su, Taoyuan County (TW); Yi-Long Hsiao, Taoyuan County (TW)

(21) Appl. No.: 13/420,624

(22) Filed: Mar. 15, 2012

(30) Foreign Application Priority Data
Sep. 7, 2011 (TW) 100132353

(51) Int. Cl. G11B 7/09

(52) U.S. Cl. 369/47.49; G9B/7.062

(57) ABSTRACT

A method for calibrating a tilt of an actuator includes the following steps: focusing a light beam projected from an objective lens onto a data layer of an optical disc; utilizing a digital signal processor to output control voltages through an analog driving circuit for driving the actuator to tilt the objective lens, and accordingly recording corresponding displacement signals of the objective lens; fitting a tilt curve through the recorded control voltages and the displacement signals; utilizing the digital signal processor to output a zero control voltage, not through the analog driving circuit, for tilting the objective lens, and accordingly measuring a standard displacement signal; acquiring a bias voltage from the tilt curve according to the standard displacement signal; and calibrating the tilt of the actuator by offsetting a control voltage outputted from the digital signal processor according to the bias voltage for controlling the analog driving circuit.

### BACKGROUND OF THE INVENTION

1. Field of the Invention

The present invention relates to an optical disc drive, and more particularly, to a method for calibrating a tilt of an actuator in a pick-up head of an optical disc drive, where the actuator is used to move an objective lens.

2. Description of the Prior Art

With the trend toward the compact and light-weight consumer electronic products, an error of a driving signal of an actuator is magnified due to a light pick-up head of an optical disc drive, resulting in a larger tilt amount of an objective lens. This may further affect the read/write accuracy of the optical disc drive.

Please refer to FIG. 1, which is a block diagram illustrating a conventional design of calibrating a tilt of an actuator. A conventional optical disc drive 10 uses a microprocessor 11 for controlling a spindle motor 12 to rotate an optical disc 13, and controlling a digital signal processor (DSP) 14 to convert a digital control signal into an analog control voltage. The analog control voltage is transmitted through an analog driving circuit 15 to drive an actuator 16 of a pick-up head to ascend/descend or tilt an objective lens 17 along a vertical or radial direction of the optical disc 13 for a servo control, such as a focusing or tracking control.

However, as the control voltage outputted from the DSP 14 is transmitted through the analog driving circuit 15 to drive the actuator 16, there is an error in the output level of the control voltage due to the electrical characteristics (e.g., the impedance) of the analog driving circuit 15. As a result, the control voltage fails to move the objective lens 17 to the desired location precisely, which affects the read/write quality of the optical disc drive. In addition, the objective lens 17 may move even beyond the maximum allowable range to crash the pick-up head. Therefore, regarding the actuator motion error, the conventional design has a calibration problem remained unsolved.

### SUMMARY OF THE INVENTION

It is one objective of the present invention to provide a method for calibrating a tilt of an actuator. A tilt curve is fitted through tilt motions of the actuator driven by a plurality of control voltages. A bias voltage is acquired from the tilt curve according to a standard displacement signal that is not obtained through an analog driving circuit, and then is used to calibrate the tilt of the actuator.

It is another objective of the present invention to provide a method for calibrating a tilt of an actuator. By offsetting a control voltage outputted from a digital signal processor according to a bias voltage, the actuator is driven precisely and thus the read/write quality is improved.

In order to achieve the above objectives, the present invention provides a method for calibrating a tilt of an actuator. The method for calibrating the tilt error of the actuator includes the following steps: focusing a light beam onto a data layer; outputting a plurality of control voltages through an analog driving circuit for driving the actuator to tilt an objective lens, and accordingly recording corresponding displacement signals (e.g., central error signals) of the objective lens; fitting a tilt curve (e.g., a linear curve); outputting a zero control voltage, not through the analog driving circuit, for tilting the objective lens, and accordingly measuring a standard displacement signal; acquiring a bias voltage from the tilt curve according to the standard displacement signal; and offsetting the plurality of control voltages to calibrate the tilt of the actuator.

In the present invention, the digital signal processor outputs the zero control voltage that is not transmitted through the analog driving circuit by turning off the analog driving circuit or setting the analog driving circuit in a high impedance mode. A difference value between the standard displacement signal and a displacement signal corresponding to the zero control voltage on the tilt curve is a tilt error generated from tilting an objective lens. The standard displacement signal is substituted into the tilt curve to obtain a correspondent standard control voltage, which is an error voltage outputted through the analog driving circuit when the digital signal processor outputs the zero control voltage, and the standard control voltage is used as the bias voltage.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a conventional design of calibrating a tilt of an actuator.

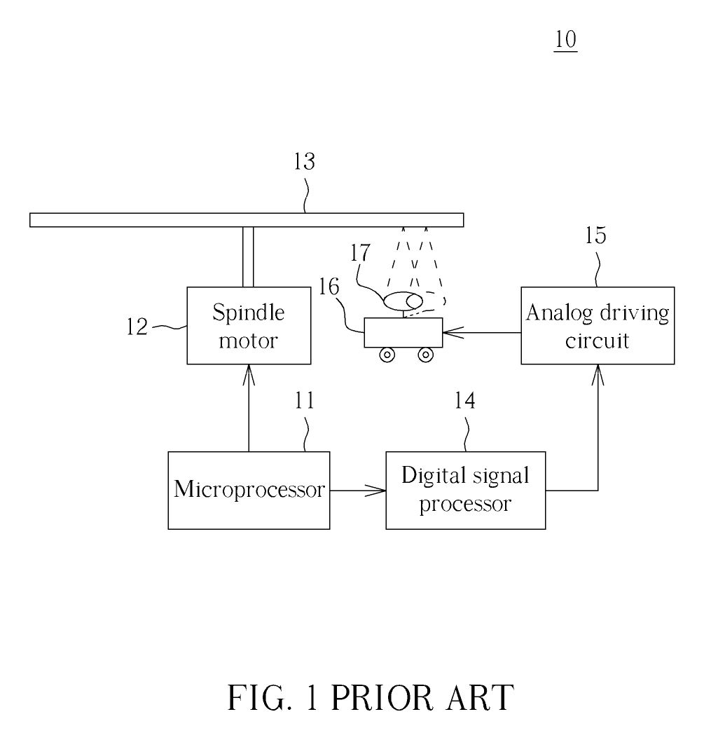

FIG. 2 is a block diagram illustrating an exemplary design of calibrating a tilt of an actuator according to an embodiment of the present invention.

FIG. 3 is a fitted tilt curve according to an embodiment of the present invention.

FIG. 4 is a flowchart illustrating a method for calibrating a tilt of an actuator according an embodiment of the present invention.

### DETAILED DESCRIPTION

With regard to technical means and utilities thereof used to achieve the above objectives of the present invention, preferred embodiments are described as follows by way of examples and with reference to the accompanying diagrams.

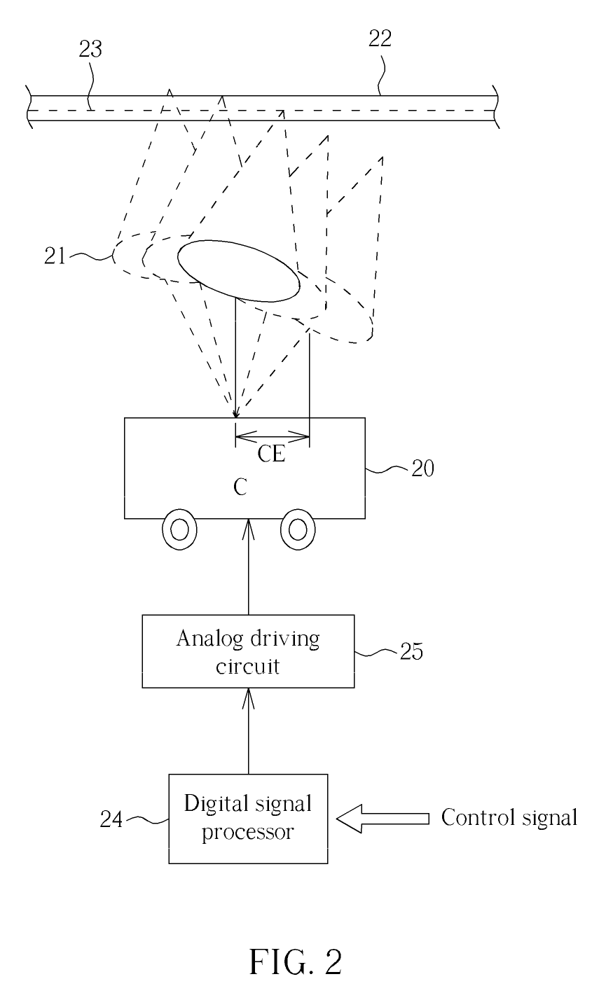

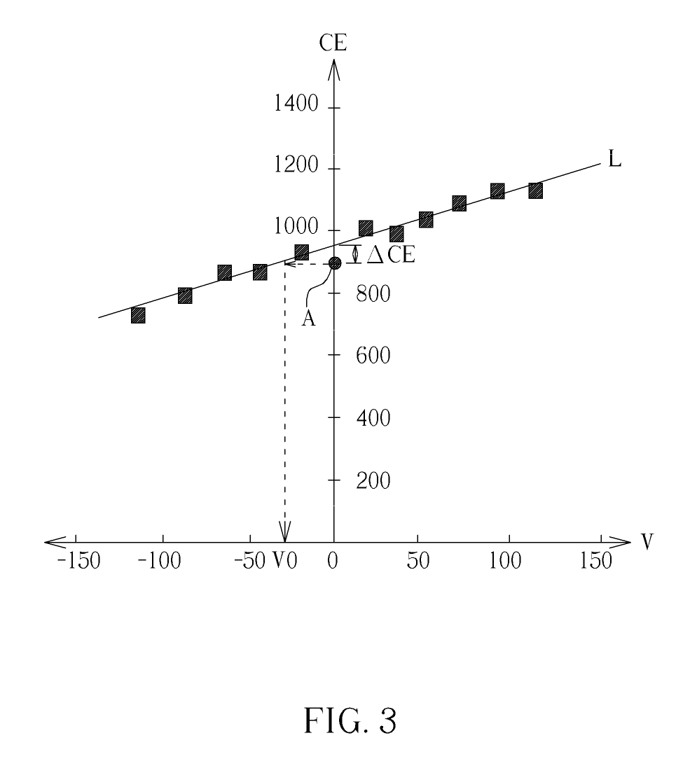

Please refer to FIG. 2 together with FIG. 3. FIG. 2 is a block diagram illustrating an exemplary design of calibrating a tilt of an actuator according to an embodiment of the present invention, and FIG. 3 is a fitted tilt curve according to an embodiment of the present invention. In FIG. 2, an exemplary method for calibrating the tilt of the actuator 20 according to the embodiment of the present invention mainly focuses on performing a calibration upon a radial tilt of the actuator 20. During the calibration performed upon the tilt of the actuator 20, in order to reduce the interference generated from driving the actuator 20 to move an objective lens 21 up and down, the actuator 20 may be driven to move the objective lens 21 up and down first, thus making a light beam projected from the objective lens 21 focused onto a data layer 23 of an optical disc 22. Next, a control signal is outputted for driving the actuator 20 to tilt the objective lens 21, and a digital signal processor 24 may convert the control signal (in the digital form) into a control voltage V (in the analog form). The control voltage V is fed through an analog driving circuit 25 for driving the actuator 20 to tilt the objective lens 21 such that the objective lens 21 moves along a radial direction of the optical disc 22. The optical disc drive may monitor an actual tilt amount of the objective lens 21 by detecting a displacement signal corresponding to the motion of the objective lens 21 (e.g., a central error (CE) signal) or a signal obtained from measuring a reflected light spot position of the objective lens 21 in an optical sensor. In this embodiment, the central error signal is taken as an example of the displacement signal, the central error signal represents a radial distance between the objective lens 21 and a central point C of the actuator 20, and the actual tilt amount of the objective lens 21 is acquired from monitoring the central error signal.

When the digital signal processor 24 outputs the control voltage V, an error is generated in the tilt amount of the objective lens 21 because the control voltage V is fed through the analog driving circuit 25 for driving the actuator 20 to tilt the objective lens 21. No standard tilt amount of the objective lens 21 may be referenced to obtain a corrected tilt amount of the objective lens 21. Therefore, as shown in FIG. 3, the present invention utilizes the digital signal processor 24 to output a plurality of control voltages through the analog driving circuit 25 for driving the actuator 20 to tilt the objective lens 21, and accordingly records corresponding displacement signals. In addition, measured data are marked in the central error signal (CE) versus control voltage (V) graph to fit a tilt curve L of the actual tilt amount of the objective lens 21. Please note that the tilt curve L shown as a linear curve is for illustrative purposes only. For example, the same objective of the present invention is achieved by using a non-linear curve (e.g., a second-order curve or a third-order curve) as the tilt curve L.

Considering a case where the digital signal processor 24 outputs a zero control voltage (i.e., V=0), if the zero control voltage does not pass through the analog driving circuit 25, the tilt amount of the objective lens 21 is not affected by the analog driving circuit 25, and thus there is no error generated therein. As a result, the present invention utilizes the digital signal processor 24 to output the zero control voltage, not through the analog drive circuit, by turning off the analog driving circuit 25 or setting the analog driving circuit in a high impedance mode, thus avoiding the generated error of the tilt amount. Next, a standard central error signal A is measured. A difference value ΔCE between the standard central error signal A and a central error signal corresponding to the zero control voltage on the tilt curve L is a tilt error generated from tilting the objective lens 21 by the actuator 20. A standard control voltage V0 corresponding to the standard central error signal A may be acquired from the tilt curve L by substituting the standard central error signal A into the tilt curve L, wherein the standard central error signal A is generated without being effected by the analog driving circuit 25. The standard control voltage V0 is regarded as a control voltage corrected by the difference value ΔCE, and is an error voltage outputted through the analog driving circuit 25 when the digital signal processor 24 outputs the zero control voltage. As the standard control voltage V0 may be regarded as an average error voltage outputted through the analog driving circuit 25, the standard control voltage V0 is used as a bias voltage outputted from the digital signal processor through the analog driving circuit 25. For example, in a case where a value of the CE signal is measured as 914 by setting the analog driving circuit 25 in a high impedance mode, the standard control voltage V0 acquired from the tilt curve L is −22, which is taken as an offset value of the control voltage outputted from the digital signal processor 24. Therefore, the present invention calibrates the tilt of the actuator 20 by offsetting the control voltage outputted from the analog driving circuit 25 according to the standard control voltage V0.

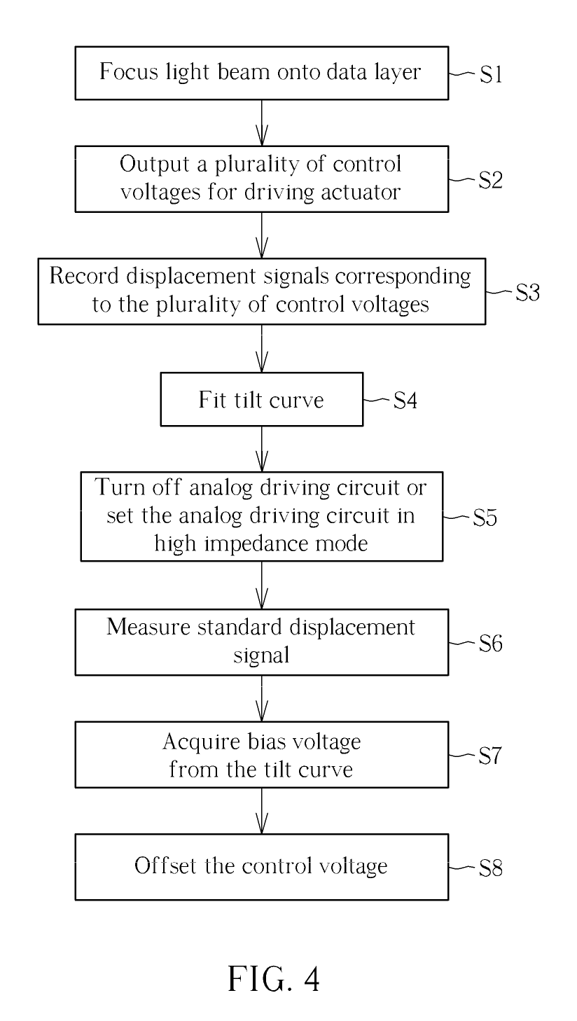

FIG. 4 is a flowchart illustrating a method for calibrating a tilt of an actuator according an embodiment of the present invention. The steps of the exemplary method are described in detail as follows. First, in step S1, the flow focuses a light beam projected from an objective lens onto a data layer of an optical disc. In step S2, the flow utilizes a digital signal processor to output a plurality of control voltages through an analog driving circuit for driving the actuator to tilt the objective lens. In step S3, the flow records corresponding displacement signals of the objective lens in sequence. In step S4, the flow fits a tilt curve through the recorded control voltages and the corresponding displacement signals. Next, in step S5, the flow turns off the analog driving circuit, or sets the analog driving circuit in a high impedance mode, and utilizes the digital signal processor to output a zero control voltage, not through the analog drive circuit, for driving the actuator to tilt the objective lens. In step S6, the flow measures a standard displacement signal. In step S7, the flow acquires a correspondent standard control voltage from the tilt curve according to the standard displacement signal, and the correspondent standard control voltage is used as a bias voltage. Finally, in step S8, the flow offsets the control voltage outputted from the digital signal processor according to the standard control voltage for controlling the analog driving circuit, thereby calibrating the tilt of the actuator.

Therefore, the exemplary method for calibrating a tilt of an actuator first fits a tilt curve of the actuator through tilt motions of the actuator and corresponding displacement signals, wherein the actuator is driven by a plurality of control voltages outputted from a digital signal processor. Next, a standard displacement signal is measured under a condition where an analog driving circuit is turned off or set in a high impedance mode. The standard displacement signal is substituted into the tilt curve to obtain a correspondent standard control voltage, and the standard control voltage is used as a bias voltage to offset the control voltage outputted from the digital signal processor. Therefore, the actuator is driven precisely, and the objective of calibrating the tilt of the actuator is achieved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for calibrating a tilt of an actuator, comprising:
(a) focusing a light beam projected from an objective lens onto a data layer of an optical disc;
(b) utilizing a digital signal processor to output a plurality of control voltages through an analog driving circuit for driving the actuator to tilt the objective lens, and accordingly recording corresponding displacement signals of the objective lens;
(c) fitting a tilt curve through the recorded control voltages and the displacement signals;
(d) utilizing the digital signal processor to output a zero control voltage, not through the analog driving circuit, for tilting the objective lens, and accordingly measuring a standard displacement signal;
(e) acquiring a bias voltage from the tilt curve according to the standard displacement signal; and
(f) calibrating the tilt of the actuator by offsetting a control voltage outputted from the digital signal processor according to the bias voltage for controlling the analog driving circuit.

2. The method for calibrating the tilt of the actuator of claim 1, wherein the digital signal processor outputs the control voltage, not through the analog driving circuit, by setting the analog driving circuit in a high impedance mode.

3. The method for calibrating the tilt of the actuator of claim 1, wherein the digital signal processor outputs the control voltage, not through the analog driving circuit, by turning off the analog driving circuit.

4. The method for calibrating the tilt of the actuator of claim 1, wherein each of the displacement signals is a central error signal.

5. The method for calibrating the tilt of the actuator of claim 1, wherein a difference value between the standard displacement signal and a displacement signal corresponding to the zero control voltage on the tilt curve is a tilt error generated from tilting the objective lens.

6. The method for calibrating the tilt of the actuator of claim 5, wherein the standard displacement signal is substituted into the tilt curve to obtain a correspondent standard control voltage, and the standard control voltage is an error voltage outputted through the analog driving circuit when the digital signal processor outputs the zero control voltage.

7. The method for calibrating the tilt of the actuator of claim 6, wherein the standard control voltage is used as the bias voltage for offsetting the control voltage outputted from the digital signal processor.

8. The method for calibrating the tilt of the actuator of claim 1, wherein the actuator tilts the objective lens along a radial direction of the optical disc.

9. The method for calibrating the tilt of the actuator of claim 1, wherein the tilt curve is a linear curve.
